(19) United States
(12) Patent Application Publication
(10) Pub. No.: US 2011/0045311 A1
(43) Pub. Date: Feb. 24, 2011

(54) OPTICAL FILM

(75) Inventor: Kiyoshi Itoh, Tokyo-to (JP)

Correspondence Address: LADAS & PARRY LLP, 224 SOUTH MICHIGAN AVENUE, SUITE 1600, CHICAGO, IL, 60604, US

(73) Assignee: DAI NIPPON PRINTING CO., LTD., Tokyo-to (JP)

(21) Appl. No.: 12/851,152

(22) Filed: Aug. 5, 2010

(30) Foreign Application Priority Data
Aug. 24, 2009 (JP) 2009-192941

(51) Int. Cl. B32B 27/06; B05D 5/06; B32B 27/00; B32B 27/36

(52) U.S. Cl. 428/480; 427/164; 428/411.1

(57) ABSTRACT

The present invention is to provide an optical film excellent in adhesion and hardness. An optical film comprising an optically-transparent substrate, an adhesion layer and a hard coat layer, the adhesion layer and the hard coat layer being provided in this order on one surface of the optically-transparent substrate, wherein the adhesion layer is made of a composition mainly comprising a resin of the same kind as a resin constituting the optically-transparent substrate, and a glass transition temperature of the adhesion layer is lower than that of the optically-transparent substrate, wherein the hard coat layer is formed of a cured product of a curable resin composition for the hard coat layer, and wherein a transition area, which has both components of the adhesion layer and the hard coat layer in a mixed state, resides between the adhesion layer and the hard coat layer.

### TECHNICAL FIELD

The present invention relates to an optical film which is used for protecting the surface of a display, etc.

### BACKGROUND ART

It is required that the image display surface of an image display device such as a liquid crystal display, a CRT display, a projection display, a plasma display, an electroluminescence display and a reflection screen is imparted with hardness to avoid being scratched upon handling.

To meet the request, in general, a hard coat (hereinafter, it may be simply referred to as “HC”) film or an optical film comprising a hard coat layer provided on a substrate is used to increase the hardness of the image display surface of an image display device (Patent Literature 1).

As a substrate of such an optical film, polyester, triacetyl cellulose (TAC), polysulfone, polypropylene, polyvinyl chloride or the like is conventionally used from the viewpoint of having optical transparency, smoothness, heat resistance and being excellent in mechanical strength.

However, in the case of providing a HC layer on the surface of a substrate, there is a problem that if the difference of height of concavity and convexity on the surface of the substrate is small and the density thereof is high, the adhesion between the substrate and the HC layer provided thereon is low. To increase the adhesion, pretreatment such as roughing the surface of the substrate by performing the corona treatment thereon, or providing a primer layer on the surface of the substrate is required. The production process of the optical film has become complicated due to the required pretreatment, and thus, the production cost has increased.

In Patent Literature 2, a composition comprising a polyester resin having a specific hydroxyl value, a thermal crosslinking agent, a photopolymerizable reactive monomer, etc. is proposed for the purpose of providing a composition for forming a cured film having high adhesion without requiring the pretreatment performed on the surface of a polyester film substrate, and having excellent hardness.

In Examples of Patent Literature 2, a HC layer is formed in such a manner that the polyester resin which contributes to increase the adhesion with the polyester substrate, and the photopolymerizable reactive monomer which serves as a matrix of a HC layer are mixed, and the obtained single composition is applied on the surface of the polyester substrate followed by ultraviolet irradiation.

### Citation List

[Patent Literature 1] Japanese Patent Application Laid-Open (JP-A) No. 2006-126808

[Patent Literature 2] JP-A No. 2008-184515

### SUMMARY OF INVENTION

### Technical Problem

However, in Patent Literature 2, there is a problem that if such a single composition containing the polyester resin and the photopolymerizable reactive monomer is used, the polyester resin, which is originally only necessary to be present in a part contacting with the polyester substrate in order to increase the adhesion with the polyester substrate, disperses to the whole HC layer, thus, a cross-linking reaction of the photopolymerizable reactive monomers is interrupted and the hardness of the HC layer does not sufficiently increase.

The present invention has been achieved to solve the above problem. An object of the present invention is to provide an optical film excellent in adhesion and hardness.

### Solution to Problem

The inventor of the present invention has tried to form a HC layer by applying a polyester resin and a binder component which serves as a matrix of the HC layer prepared in separate compositions and not in a single composition. However, the adhesion between the polyester resin and the HC layer has not been obtained. In addition, interference fringes have occurred due to the difference of the refractive index between the polyester resin and the HC layer.

As a result of further diligent researches, the inventor of the present invention has found out that by preparing three compositions, which are a composition (A) comprising a polyester resin and a solvent, a composition (B) comprising a binder component and a solvent, and a composition (C) comprising both the polyester resin of the composition (A) and the binder component of the composition (B) , wherein the total concentration of the polyester resin and the binder component is higher than the concentration of the polyester resin in the composition (A) and the concentration of the binder component in the composition (B), and performing simultaneous application of the composition (A), the composition (C) and the composition (B) so that a coating of the composition (A), a coating of the composition (C), and a coating of the composition (B) are formed in this order on the surface of the optically-transparent substrate followed by curing the coatings, mixing of the compositions (A) and (B) can be prevented, whereby an adhesion layer comprising the polyester resin having excellent adhesion toward a polyester substrate is formed adjacent to the polyester substrate, and a HC layer is formed on the adhesion layer, in addition, a transition area, which has the polyester resin and the binder component in a mixed state, derived from the composition (C) resides between the adhesion layer and the HC layer, so that occurrence of interference fringes between the adhesion layer of the polyester resin and the HC layer can be prevented, thereby, an optical film having adhesion between the adhesion layer and the polyester substrate and a sufficient hardness in a HC layer can be obtained. Thus, the present invention has been completed.

That is, a first optical film of the present invention comprises an optically-transparent substrate, an adhesion layer and a hard coat layer, the adhesion layer and the hard coat layer being provided in this order on one surface of the optically-transparent substrate,

wherein the adhesion layer is made of a composition mainly comprising a resin of the same kind as a resin constituting the optically-transparent substrate, and a glass transition temperature of the adhesion layer is lower than that of the optically-transparent substrate,

wherein the hard coat layer is formed of a cured product of a curable resin composition for the hard coat layer, and

wherein a transition area, which has both components of the adhesion layer and the hard coat layer in a mixed state, resides between the adhesion layer and the hard coat layer.

The adhesion layer is made of the composition mainly comprising a resin of the same kind as the resin constituting the optically-transparent substrate, thus, the adhesion between the optically-transparent substrate and the adhesion layer can be excellent. Also, the transition area has functions of inhibiting occurrence of interference fringes between the adhesion layer and the HC layer in addition to increasing adhesion between the adhesion layer and the HC layer. Therefore, the first optical film of the present invention has excellent adhesion and is excellent in appearance as occurrence of interference fringes can be inhibited. In the present invention, resins of the same kind include not only the same resin but also derivatives thereof regardless of molecular weight. Also, the resins of the same kind include resins which have different monomers in apart of the copolymer but have the same monomer as the main monomer, which has the highest content among the monomers in the copolymer. “Mainly comprising a resin of the same kind as . . . ” means that, in a composition, the content of the resin of the same kind is highest on a solid content basis. The glass transition temperature is a value obtained by measurement by means of an auto differential scanning calorimeter (product name: DSC-60A; manufactured by Shimadzu Corporation).

In a preferred embodiment of the first optical film of the present invention, excellent adhesion and hardness can be obtained even if the optically-transparent substrate is an optically-transparent substrate having an untreated surface.

In the first optical film of the present invention, from the viewpoint of increasing adhesion between the optically-transparent substrate and the adhesion layer, it is preferable that the optically-transparent substrate having an untreated surface is a polyethylene terephthalate substrate, and the resin in the adhesion layer is amorphous polyethylene terephthalate.

A second optical film of the present invention comprises an optically-transparent substrate, an adhesion layer and a hard coat layer, the adhesion layer and the hard coat layer being provided in this order on one surface of the optically-transparent substrate,

wherein the adhesion layer is made of a composition mainly comprising a resin of the same kind as a resin constituting the optically-transparent substrate, and an absolute value of difference between solubility parameter of the adhesion layer and solubility parameter of the optically-transparent substrate is 2 or less, the solubility parameter being calculated from square root of cohesive energy density,

wherein the hard coat layer is formed of a cured product of a curable resin composition for the hard coat layer, and

wherein a transition area, which has both components of the adhesion layer and the hard coat layer in a mixed state, resides between the adhesion layer and the hard coat layer.

The adhesion layer is made of the composition mainly comprising the resin of the same kind as the resin constituting the optically-transparent substrate, and the absolute value of difference between solubility parameter of the adhesion layer and solubility parameter of the optically-transparent substrate is 2 or less, the solubility parameter being calculated from square root of cohesive energy density, thereby, the adhesion layer can exhibit excellent adhesion with the optically-transparent substrate. The transition area has functions of inhibiting occurrence of interference fringes between the adhesion layer and the HC layer, in addition to increasing adhesion between the adhesion layer and the HC layer. Therefore, the second optical film of the present invention has excellent adhesion and is excellent in appearance as occurrence of interference fringes can be inhibited.

In a preferred embodiment of the second optical film of the present invention, excellent adhesion and hardness can be obtained even if the optically-transparent substrate is an optically-transparent substrate having an untreated surface.

In the second optical film of the present invention, from the viewpoint of increasing adhesion between the optically-transparent substrate and the adhesion layer, it is preferable that the optically-transparent substrate having the untreated surface is a polyethylene terephthalate substrate, and the resin in the adhesion layer is amorphous polyethylene terephthalate.

A third optical film of the present invention can be obtained by the steps of:

preparing a composition for an adhesion layer comprising a resin of the same kind as a resin constituting an optically-transparent substrate and a first solvent, wherein the resin has a glass transition temperature lower than that of the optically-transparent substrate,

a curable resin composition for a hard coat layer comprising a binder component having photocurability and a second solvent, and

a composition for forming a transition area comprising a resin of the same kind as the resin constituting the optically-transparent substrate, a binder component having photocurability and a third solvent, wherein the resin has a glass transition temperature lower than that of the optically-transparent substrate, and wherein a total content rate of the resin and the binder component with respect to a total amount of the resin, the binder component and the third solvent in the composition for forming the transition area is higher than a content rate of the resin with respect to a total amount of the resin and the first solvent in the composition for the adhesion layer, and is higher than a content rate of the binder component with respect to a total amount of the binder component and the second solvent in the curable resin composition for the hard coat layer;

performing simultaneous application of the composition for the adhesion layer, the composition for forming the transition area, and the curable resin composition for the hard coat layer on one surface of the optically-transparent substrate so that a coating of the composition for the adhesion layer, a coating of the composition for forming the transition area, and a coating of the curable resin composition for the hard coat layer are formed in this order on the surface of the optically-transparent substrate; and

drying the coatings followed by curing the coating of the curable resin composition for the hard coat layer with light irradiation.

Since the total content rate of the resin of the same kind as the resin constituting the optically-transparent substrate and having the specific glass transition temperature, and the binder component in the composition for forming the transition area is higher than the content rate of the resin in the composition for the adhesion layer and the content rate of the binder component in the curable resin composition for the HC layer, and the HC layer is formed by performing simultaneous application of the above three compositions so that the coatings of the above three compositions are formed in the above specific order on the surface of the optically-transparent substrate, it can be inhibited that the composition for the adhesion layer and the curable resin composition for the HC layer are mixed to be in a uniform state, and the resin and the binder component in the composition for forming the transition area disperse into the composition for the adhesion layer or the curable resin composition for the HC layer having high affinity with themselves respectively. Thereby, the transition area having functions of exhibiting adhesion between the adhesion layer and the HC layer, and inhibiting occurrence of interference fringes between the adhesion layer and the HC layer, can be formed without forming an interface between the transition area and the adhesion layer, and between the transition area and the hard coat layer.

In a preferred embodiment of the third optical film of the present invention, excellent adhesion and hardness can be obtained even if the optically-transparent substrate is an optically-transparent substrate having an untreated surface.

In the third optical film of the present invention, from the viewpoint of increasing adhesion between the optically-transparent substrate and the adhesion layer, it is preferable that the optically-transparent substrate having the untreated surface is a polyethylene terephthalate substrate, and the resin in the composition for the adhesion layer is amorphous polyethylene terephthalate.

In the third optical film of the present invention, the simultaneous application is preferably performed by a slide coater from the viewpoint of productivity, and uniformity of thickness of each layer.

In the third optical film of the present invention, from the viewpoint of easy formation of the transition area, it is preferable that the content rate of the resin with respect to the total amount of the resin and the first solvent in the composition for the adhesion layer is 30 to 50 weight %,

the content rate of the binder component with respect to the total amount of the binder component and the second solvent in the curable resin composition for the hard coat layer is 30 to 50 weight %, and

the content rate of the total amount of the resin and the binder component with respect to the total amount of the resin, the binder component and the third solvent in the composition for forming the transition area is 50 to 80 weight %

A fourth optical film of the present invention can be obtained by the steps of:

preparing a composition for an adhesion layer comprising a resin of the same kind as a resin constituting an optically-transparent substrate and a first solvent, wherein an absolute value of difference between solubility parameter of the resin and solubility parameter of the optically-transparent substrate is 2 or less, the solubility parameter being calculated from square root of cohesive energy density,

a curable resin composition for a hard coat layer comprising a binder component having photocurability and a second solvent, and

a composition for forming a transition area comprising a resin of the same kind as the resin constituting the optically-transparent substrate, a binder component having photocurability and a third solvent, wherein an absolute value of difference between solubility parameter of the resin and solubility parameter of the optically-transparent substrate is 2 or less, and wherein a total content rate of the resin and the binder component with respect to a total amount of the resin, the binder component and the third solvent in the composition for forming the transition area is higher than a content rate of the resin with respect to a total amount of the resin and the first solvent in the composition for the adhesion layer, and is higher than a content rate of the binder component with respect to a total amount of the binder component and the second solvent in the curable resin composition for the hard coat layer;

performing simultaneous application of the composition for the adhesion layer, the composition for forming the transition area, and the curable resin composition for the hard coat layer on one surface of the optically-transparent substrate so that a coating of the composition for the adhesion layer, a coating of the composition for forming the transition area, and a coating of the curable resin composition for the hard coat layer are formed in this order on the surface of the optically-transparent substrate; and

drying the coatings followed by curing the coating of the curable resin composition for the hard coat layer with light irradiation.

Since the total content rate of the resin of the same kind as the resin constituting the optically-transparent substrate and having the specific solubility parameter, and the binder component in the composition for forming the transition area is higher than the content rate of the resin in the composition for the adhesion layer and the content rate of the binder component in the curable resin composition for the HC layer, and the HC layer is formed by performing simultaneous application of the above three compositions so that the coatings of the above three compositions are formed in the above specific order on the surface of the optically-transparent substrate, it can be inhibited that the composition for the adhesion layer and the curable resin composition for the HC layer are mixed to be in a uniform state, and the resin and the binder component in the composition for forming the transition area disperse into the composition for the adhesion layer or the curable resin composition for the HC layer having high affinity with themselves respectively. Thereby, the transition area having functions of exhibiting adhesion between the adhesion layer and the HC layer, and inhibiting occurrence of interference fringes between the adhesion layer and the HC layer, can be formed without forming an interface between the transition area and the adhesion layer, or between the transition area and the hard coat layer.

In a preferred embodiment of the fourth optical film of the present invention, excellent adhesion and hardness can be obtained even if the optically-transparent substrate is an optically-transparent substrate having an untreated surface.

In the fourth optical film of the present invention, from the viewpoint of increasing adhesion between the optically-transparent substrate and the adhesion layer, it is preferable that the optically-transparent substrate having the untreated surface is a polyethylene terephthalate substrate, and the resin in the composition for the adhesion layer is amorphous polyethylene terephthalate.

In the fourth optical film of the present invention, the simultaneous application is preferably performed by a slide coater from the viewpoint of productivity, and uniformity of thickness of each layer.

In the fourth optical film of the present invention, from the viewpoint of easy formation of the transition area, it is preferable that the content rate of the resin with respect to the total amount of the resin and the first solvent in the composition for the adhesion layer is 30 to 50 weight %,

the content rate of the binder component with respect to the total amount of the binder component and the second solvent in the curable resin composition for the hard coat layer is 30 to 50 weight %, and

the content rate of the total amount of the resin and the binder component with respect to the total amount of the resin, the binder component and the third solvent in the composition for forming the transition area is 50 to 80 weight %.

### ADVANTAGEOUS EFFECTS OF INVENTION

The adhesion layer is made of the composition mainly comprising the resin of the same kind as the resin constituting the optically-transparent substrate, and the glass transition temperature of the adhesion layer is lower than that of the optically-transparent substrate, or the absolute value of difference between solubility parameter of the adhesion layer and solubility parameter of the optically-transparent substrate is 2 or less, thereby, the adhesion layer has excellent adhesion with the optically-transparent substrate. In addition, by the transition area having both components of the adhesion layer and the HC layer in a mixed state, difference of the refractive index between the adhesion layer and the HC layer can be decreased. Therefore, the optical film of the present invention has excellent hardness and adhesion, and is excellent in appearance as occurrence of interference fringes can be inhibited. Also, since the HC layer is formed by performing simultaneous application of the composition for the adhesion layer, the curable resin composition for the HC layer and the composition for forming the transition area comprising the resin of the same kind as the resin constituting the optically-transparent substrate and/or the binder component at a specific content rate, an optical film having the above characteristics can be obtained.

### BRIEF DESCRIPTION OF DRAWINGS

FIG. 1 is a view schematically showing an example of a layer structure of an optical film of the present invention.

FIG. 2 is a view schematically showing another example of a layer structure of an optical film of the present invention.

FIG. 3 is a view schematically showing an example of simultaneous multilayer application in the production process of the optical film of the present invention.

FIG. 4 is a view schematically showing the simultaneous multilayer application in the production process of the optical film of Comparative example 1.

### REFERENCE SIGNS LIST

1. Optical film

10. Optically-transparent substrate

20. Adhesion layer

30. Hard coat layer

40. Transition area

50. Low refractive index layer

60. Coating head

70. Slide surface

80. Composition for an adhesion layer

90. Composition for forming a transition area

100. Curable resin composition for a hard coat layer

110. Roller

### DESCRIPTION OF EMBODIMENTS

Hereinafter, the optical film of the present invention and the method for producing the same will be described in order.

In the present invention, “(meth)acrylate” means acrylate and/or methacrylate.

In the present invention, “light” includes not only electromagnetic waves having a wavelength in the visible and those having a wavelength in the nonvisible region but also particle beams (e.g. electron beams) and ionizing radiation or radiation, which is a general term for electromagnetic waves and particle beams.

In the present invention, “layer thickness” means the thickness of a dried layer (dried layer thickness) if not particularly mentioned.

In the present invention, “hard coat layer” means a layer which has a hardness of “H” or more on the pencil hardness test with a load of 4.9 N defined in JIS K5600-5-4 (1999).

In the definition of a film and sheet in JIS-K6900, a sheet means a thin and flat product in which the thickness of the sheet is generally thin considering the length and width thereof, and a film means a thin and flat product in which the thickness of the film is significantly thin compared with the length and width thereof and the maximum thickness is arbitrarily limited, generally provided in a form of a roll. Therefore, it can be said that a sheet having a particularly thin thickness among sheets is a film. However, the boundary between sheets and films is unclear and it is difficult to precisely distinguish the difference between sheets and films. Accordingly, in the present invention, the definition of “film” includes both one having a thick thickness and one having a thin thickness.

In the present invention, “molecular weight” means a polystyrene-equivalent weight average molecular weight measured by gel permeation chromatography (GPC) in the case where a compound has a molecular weight distribution. In the case where a compound has no molecular weight distribution, “molecular weight” means the molecular weight of the compound itself.

### (Optical Film)

A first optical film of the present invention comprises an optically-transparent substrate, an adhesion layer and a hard coat layer, the adhesion layer and the hard coat layer being provided in this order on one surface of the optically-transparent substrate,

wherein the adhesion layer is made of a composition mainly comprising a resin of the same kind as a resin constituting the optically-transparent substrate, and a glass transition temperature of the adhesion layer is lower than that of the optically-transparent substrate,

wherein the hard coat layer is formed of a cured product of a curable resin composition for the hard coat layer, and

wherein a transition area, which has both components of the adhesion layer and the hard coat layer in a mixed state, resides between the adhesion layer and the hard coat layer.

A second optical film of the present invention comprises an optically-transparent substrate, an adhesion layer and a hard coat layer, the adhesion layer and the hard coat layer being provided in this order on one surface of the optically-transparent substrate,

wherein the adhesion layer is made of a composition mainly comprising a resin of the same kind as a resin constituting the optically-transparent substrate, and an absolute value of difference between solubility parameter of the adhesion layer and solubility parameter of the optically-transparent substrate is 2 or less, the solubility parameter being calculated from square root of cohesive energy density,

wherein the hard coat layer is formed of a cured product of a curable resin composition for the hard coat layer, and

wherein a transition area, which has both components of the adhesion layer and the hard coat layer in a mixed state, resides between the adhesion layer and the hard coat layer.

The adhesion layer is made of the composition mainly comprising the resin of the same kind as the resin constituting the optically-transparent substrate, and the glass transition temperature of the adhesion layer is lower than that of the optically-transparent substrate, or the absolute value of difference between solubility parameter of the adhesion layer and solubility parameter of the optically-transparent substrate is 2 or less, the solubility parameter being calculated from square root of cohesive energy density, thereby, the adhesion layer can exhibit excellent adhesion with the optically-transparent substrate. In addition, difference of the refractive index between the adhesion layer and the HC layer can be decreased by the transition area having both components of the adhesion layer and the HC layer in a mixed state, and there is no interface in the transition area, thereby, the optical film of the present invention is excellent in appearance as occurrence of interference fringes can be inhibited.

Since the optical film of the present invention has excellent hardness and is excellent in appearance as described above, the optical film can be suitably used in touch panel applications besides protection applications of a general display.

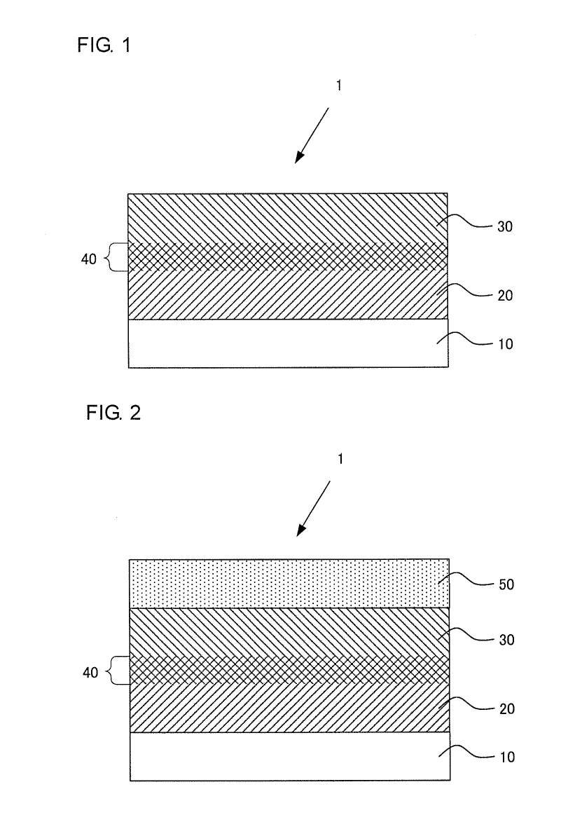

FIG. 1 is a view schematically showing an example of a layer structure of the optical film of the present invention.

The optical film 1 comprises an optically-transparent substrate 10, an adhesion layer 20 and a hard coat layer 30, the adhesion layer 20 and the hard coat layer 30 being provided in this order on one surface of the optically-transparent substrate 10. A transition area 40, which has both components of the adhesion layer 20 and the HC layer 30 in a mixed state, resides between the adhesion layer 20 and the HC layer 30.

FIG. 2 is a view schematically showing another example of a layer structure of the optical film of the present invention.

The optical film 1 comprises an optically-transparent substrate 10, an adhesion layer 20, a hard coat layer 30 and a low refractive index layer 50, the adhesion layer 20, the hard coat layer 30 and the low refractive index layer 50 being provided in this order on one surface of the optically-transparent substrate 10. Similarly as in FIG. 1, the transition area 40, which has both components of the adhesion layer 20 and the HC layer 30 in a mixed state, resides between the adhesion layer 20 and the HC layer 30.

Hereinafter, essential components of the optical film of the present invention, the optically-transparent substrate, the adhesion layer and the hard coat layer, and other layers such as a low refractive index layer and an anti-fouling layer, which may be provided as needed, will be described.

### (Optically-transparent Substrate)

The optically-transparent substrate of the present invention is not particularly limited as long as it has physical properties that are required for the optically-transparent substrate of the optical film. The optically-transparent substrate which is used in conventionally-known hard coat films or optical films, including triacetyl cellulose, polyester, and a cycloolefin polymer, may be appropriately selected for use.

Examples of polyester include polyethylene terephthalate (hereinafter, it may be referred to as PET) and polyethylenenaphthalate(PEN). Among them, PET is preferable, and biaxially-oriented PET is more preferable.

The surface treatment such as saponification treatment or providing a primer layer may be performed on the optically-transparent substrate, or no surface treatment may be performed thereon. Ina preferred embodiment of the optical film of the present invention, even if the surface treatment is not performed on the optically-transparent substrate, excellent adhesion and hardness can be obtained since the resin of the same kind as the resin constituting the optically-transparent substrate contained in the composition for the adhesion layer that will be described hereinafter increases the adhesion of the adhesion layer with the optically-transparent substrate.

In addition, an additive such as an anti-static agent may be added to the optically-transparent substrate.

In a preferred embodiment of the optical film of the present invention, in the case that a PET substrate is used as the optically-transparent substrate, the adhesion between the optically-transparent substrate and the adhesion layer can be increased by using amorphous polyethylene terephthalate as the resin of the same kind as the resin constituting the optically-transparent substrate contained in the composition for the adhesion layer that will be described hereinafter.

The thickness of the optically-transparent substrate is not particularly limited, and is generally from about 30 to about 200 μm, preferably from 40 to 200 μm.

An average light transmittance of the optically-transparent substrate in the visible light region from 380 to 780 nm is preferably 50% or more, more preferably 70% or more, still more preferably 85% or more. Light transmittance is measured by means of an ultraviolet-visible spectrophotometer (product name: UV-3100PC; manufactured by Shimadzu Corporation) and values obtained at room temperature in the air are used.

### (Adhesion Layer)

The adhesion layer of the present invention is made of a composition for the adhesion layer comprising a resin of the same kind as a resin constituting the optically-transparent substrate and a first solvent. In the first optical film, a glass transition temperature of the adhesion layer is lower than that of the optically-transparent substrate. In the second optical film, an absolute value of difference between solubility parameter of the adhesion layer and solubility parameter of the optically-transparent substrate is 2 or less, the solubility parameter being calculated from square root of cohesive energy density.

The thickness of the adhesion layer may be appropriately set. For example, the thickness is preferably from 100 to 3,000 nm from the viewpoint of ensuring functions such as hard coat property.

The adhesion rate of the adhesion layer of the present invention is preferably 95% or more when the adhesion is evaluated as described below. In accordance with a method of a cross cut test defined in JIS K5400, 11 lengthwise cuts and 11 crosswise cuts are made at 1 mm intervals on the surface of the hard coat layer of the optical films to make 100 squares. Then, Cellotape (registered trademark; manufactured by Nichiban Co., Ltd.) is applied on the squares, and promptly pulled in a right angled direction to peel the squares. The ratio of squares remained without peeling, which is calculated based on the following criteria, is referred to as adhesion rate.

Adhesion rate (%)=(the number of squares remained without peeling/100 [total number of squares])×100

Hereinafter, the composition for the adhesion layer which forms the adhesion layer will be described.

### (Composition for Adhesion Layer)

It is preferable that a composition for the adhesion layer comprises a resin of the same kind as a resin constituting the optically-transparent substrate and a first solvent wherein the resin has a glass transition temperature lower than that of the optically-transparent substrate, and is dried to form the adhesion layer.

The resin contained in the adhesion layer, which is the same kind as the resin constituting the optically-transparent substrate and has the glass transition temperature lower than that of the optically-transparent substrate, can exhibit adhesion with the optically-transparent substrate. The resin contained in the adhesion layer is the resin of the same kind as the resin constituting the optically-transparent substrate, and thus, has high affinity with the optically-transparent substrate, and occurrence of interference fringes can be inhibited. In addition, the resin contained in the adhesion layer has lower glass transition temperature than that of the optically-transparent substrate, and thus, has coatability.

In the present invention, resins of the same kind include not only the same resin but also derivatives thereof regardless of molecular weight. Also, the resins of the same kind include resins which have different monomers in a part of the copolymer but have the same monomer as the main monomer, which has the highest content among the monomers in the copolymer. It is preferable that about 50 mol % or more, more preferably 80 mol % or more, even more preferably 90 mol % or more, of all repeating units constituting a molecule of one resin conforms to the repeating units constituting a molecule of the other resin. For example, it is preferable that the resin contained in the adhesion layer has the same repeating unit as a repeating unit contained in one molecule of the resin constituting the optically-transparent substrate at a rate of 90 mol % or more, and the content rate of the repeating unit is 50 mol % or more, more preferably 80 mol % or more, even more preferably 90% or more, in one molecule of the resin contained in the adhesion layer.

The glass transition temperature of the resin of the same kind as the resin constituting the optically-transparent substrate contained in the adhesion layer is preferably 60° C. or more so that the resin does not melt by the heat generated upon light irradiation to the coating of the curable resin composition for the HC layer that will be described hereinafter. For example, if the optically-transparent substrate is PET having a glass transition temperature of 120° C., the glass transition temperature of the resin of the same kind as the resin constituting the optically-transparent substrate contained in the adhesion layer is preferably from 60 to 80° C. from the viewpoint of coatability, and heat resistance toward the heat upon light irradiation.

The glass transition temperature of the resin which is the same kind as the resin constituting the optically-transparent substrate is preferably from about 10 to 100° C., and further from about 20 to 70° C. lower than that of the optically-transparent substrate from the viewpoint of coatability, and heat resistance toward the heat upon light irradiation.

The resin of the same kind as the resin constituting the optically-transparent substrate in the composition for the adhesion layer may be a resin in which the absolute value of difference between solubility parameter of the same kind of resin and solubility parameter of the optically-transparent substrate is 2 or less, the solubility parameter being calculated from square root of cohesive energy density, instead of being a resin having lower glass transition temperature than that of the optically-transparent substrate (hereinafter, the resin of the same kind includes the resin having lower glass transition temperature than that of the optically-transparent substrate, and the resin in which the absolute value of difference between solubility parameter of the resin and solubility parameter of the optically-transparent substrate is 2 or less, if not particularly mentioned). Since the absolute value of difference of solubility parameter is 2 or less, the resin of the same kind as the resin constituting the optically-transparent substrate in the adhesion layer has excellent affinity with the optically-transparent substrate. Thereby, sufficient adhesion can be obtained, and occurrence of interference fringes between the adhesion layer and the optically-transparent substrate can be also inhibited. In addition, the absolute value of difference of solubility parameters is preferably 0.5 or less.

Solubility parameter is calculated from square root of cohesive energy density. Specifically, it can be calculated by the method mentioned in Gold Book—solubility parameter of International Union of Pure and Applied Chemistry (IUPAC).

An example of the resin of the same kind as the resin constituting the optically-transparent substrate in the adhesion layer, which has the glass transition temperature and/or the solubility parameter as described above, includes an amorphous component in the optically-transparent substrate. If the optically-transparent substrate is a PET substrate (glass transition temperature: about 120° C.; solubility parameter: 11.5), one example of the resin of the same kind as the resin constituting the optically-transparent substrate contained in the adhesion layer is amorphous PET (glass transition temperature: 60 to 90° C.; solubility parameter: 11). If the optically-transparent substrate is a TAC substrate (glass transition temperature: about 170° C.; solubility parameter: 10.9), one example of the resin of the same kind as the resin constituting the optically-transparent substrate contained in the adhesion layer is cellulose acetate (glass transition temperature: about 160° C.; solubility parameter: 10 to 11) having a high rate of acetylation such as the rate of 50 to 63%.

The rate of acetylation means weight percent of acetic acid being released per unit weight when cellulose acetate is saponified, and is a value calculated by the following method.

1.9 g of cellulose acetate, which is dried at 100° C. under the humidity of 55% for two hours, is precisely weighed and dissolved in 150 mL of a mixed solution of acetone and dimethyl sulfoxide (capacity ratio: 4:1) followed by adding 30 mL of 1N-sodium hydroxide aqueous solution, and is saponified at 25° C. for 2 hours. Phenolphthalein is added therein as an indicator, and excess sodium hydroxide is titrated with 1N-sulfuric acid (concentration factor: F). A blank test is carried out by the same method, and the rate of acetylation is calculated in accordance with the following Formula (1):

Rate of acetylation (%)={6.5×(B−A)×F}/W Formula (1)

wherein “A” represents titer (mL) of 1N-sulfuric acid in a sample, “B” represents titer (mL) of 1N-sulfuric acid in the blank test, “F” represents concentration factor of 1N-sulfuric acid, and “W” represents weight of the sample.

### (First Solvent)

The first solvent is a component for adjusting viscosity of the composition for the adhesion layer, and imparting coatability to the composition for the adhesion layer.

As the first solvent, a conventionally-known solvent of the composition for the HC layer can be used. For example, alcohols such as isopropyl alcohol, methanol and ethanol, ketones such as methyl ethyl ketone, methyl isobutyl ketone and cyclohexanone, esters such as ethyl acetate and butyl acetate, or aromatic hydrocarbon such as toluene and xylene can be used.

These solvents may be used alone or in combination of two or more kinds.

The first solvent of the composition for the adhesion layer may be the same as or different from a second solvent of the curable resin composition for the HC layer, and/or a third solvent of a composition for forming a transition area that will described hereinafter.

### Thermal Crosslinking Agent)

If amorphous PET is contained in the composition for the adhesion layer as the resin of the same kind as the resin constituting the optically-transparent substrate, it is preferable that a thermal crosslinking agent is further contained therein.

The thermal crosslinking agent is a component which causes cross-linking reaction with a hydroxyl group of a PET substrate or amorphous PET. A conventionally-known compound such as an isocyanate compound or a carbodiimide compound can be used. For example, a thermal crosslinking agent such as tolylene diisocyanate or hexamethylene diisocyanate disclosed in JP-A No. 2008-184515 can be used.

The content of the thermal crosslinking agent is preferably from 10 to 40 parts by weight, more preferably from 20 to 35 parts by weight, with respect to 100 parts by weight of the solid content of amorphous PET. By setting the content of the thermal crosslinking agent in the range from 10 to 40 parts by weight, a sufficient cross-linking density can be obtained.

### (Hard Coat Layer)

The hard coat layer of the present invention is formed of a cured product of a curable resin composition for the hard coat layer, and imparts hardness to the optical film.

The thickness of the HC layer may be appropriately adjusted if necessary, and is preferably from 1 to 5 μm.

Hereinafter, the curable resin composition for the HC layer, which is cured to form the HC layer, will be described.

### (Curable Resin Composition for Hard Coat Layer)

The curable resin composition for the HC layer comprises a binder component having photocurability and a second solvent, and is dried followed by light irradiation to cure. Thus, the HC layer is formed.

### (Binder Component)

As the binder component contained in the curable resin composition for the HC layer, a conventionally-known binder component of the HC layer can be used. For example, ethyl (meth) acrylate, ethylhexyl(meth)acrylate, pentaerythritol tri(meth)acrylate, or dipentaerythritol hexa(meth)acrylate disclosed in JP-A No. 2008-184515 can be used.

Besides the above, an oligomer such as epoxy acrylate, urethane acrylate, polyester acrylate, polybutadieneacrylate or silicon acrylate may be used.

The above binder components may be used alone or in combination of two or more kinds.

The content rate of the binder component in the curable resin composition for the HC layer with respect to the total amount of the binder component and the second solvent that will be described hereinafter may be appropriately adjusted in accordance with required coatability, and is preferably from 30 to 50 weight % from the viewpoint of coatability of the curable resin composition of the HC layer, and from the view point that the transition area can be easily formed by appropriately inhibiting mixing of the binder component in the curable resin composition for the HC layer and the binder component or the like contained in the composition for forming the transition area.

### (Second Solvent)

The second solvent is a component for adjusting viscosity of the curable resin composition for the HC layer, and imparting coatability to the curable resin composition for the HC layer.

As the second solvent, one described in the first solvent can be used.

The second solvent may be used alone or in combination of two or more kinds.

The first solvent of the composition for the adhesion layer may be the same as or different from the second solvent of the curable resin composition for the HC layer and/or a third solvent of a composition for forming a transition area that will be described hereinafter.

The curable resin composition for the HC layer may contain a polymerization initiator, an anti-static agent, a leveling agent, a functional fine particle, and an antimicrobial agent, besides the binder component.

### (Polymerization Initiator)

Any of radical and cationic polymerization initiators may be appropriately selected for use, if necessary. These polymerization initiators are decomposed by light irradiation and/or heating to generate radicals or cations, thereby, radical polymerization and/or cationic polymerization is promoted. An example of the radical polymerization initiator includes Irgacure 184 (product name; manufactured by Ciba Japan K. K.; 1-hydroxy-cyclohexyl-phenyl-ketone).

In the case of using the polymerization initiator, the content thereof is preferably from 1 to 10 weight % with respect to the total amount of the curable resin composition for the HC layer.

### (Anti-static Agent)

As an anti-static agent, a conventionally-known anti-static agent can be used. For example, a cationic anti-static agent such as a quaternary ammonium salt, and a fine particle such as indium tin oxide (ITO) disclosed in JP-A No. 2007-264221 can be used. The content thereof is preferably from 10 to 50 weight % with respect to the total amount of the curable resin composition for the HC layer.

### (Leveling Agent)

A leveling agent has function of imparting coating stability, slidability, anti-fouling property or abrasion resistance to the surface of a coating at the time of applying the composition or drying the applied composition.

As the leveling agent, a leveling agent such as a florinated leveling agent or silicone leveling agent, which is used for the conventionally-known HC layer and anti-fouling layer, can be used. For example, both the leveling agent having no ionizing radiation-curable groups such as MEGAFACE series (product name: MCF350-5; manufactured by DIC Corporation) and the leveling agent having ionizing radiation-curable groups such as X22-163A (product name; manufactured by Shin-Etsu Chemical Co., Ltd.) can be used.

The content of the leveling agent is preferably from 1 to 10 weight % with respect to the total amount of the curable resin composition for the HC layer.

### (Functional Fine Particle)

A functional fine particle is a component for imparting function such as hardness and control capability of refractive index to the HC layer, and a conventionally-known fine particle used for the HC layer can be used.

For example, a silica fine particle having excellent hardness can be used to impart hardness to the HC layer. The silica fine particle may be a reactive silica fine particle having an organic component which can be cross-linked to the binder component on the surface of the particle, which is disclosed in JP-A No. 2008-165041. The reactive silica fine particle cross-links with the binder component, thus, the hardness of the HC layer can further increase.

To control the refractive index of the HC layer, a low refractive index fine particle including a fluoride fine particle such as sodium fluoride, and a hollow silica fine particle may be used, or a high refractive index fine particle such as antimony doped tin oxide (ATO), phosphorus doped tin oxide (PTO), zirconia (ZrO₂) or antimony oxide (Sb₂O₅) may be used.

### (Antimicrobial Agent)

The optical film of the present invention can be suitably used for touch panel applications. In the touch panel applications, antimicrobial property is preferably imparted by adding an antimicrobial agent since touch panels have many opportunities to be touched by fingers. As the antimicrobial agent, a commercially available industrial antimicrobial agent can be used. An industrial antimicrobial agent includes an organic antimicrobial agent and an inorganic antimicrobial agent, and either one may be used.

Examples of the inorganic antimicrobial agent include NOVARON AG330, AG020, AG300 and AG1100 (product names; manufactured by Toagosei Co., Ltd.).

Examples of the organic antimicrobial agent include NK Economer ADP-51, ADP-33, AL, AL-4G, AL-8G, AL-12G, ML, ML-4G, ML-8G and ML-12G (product names; manufactured by Shin-Nakamura Chemical Co., Ltd.), and BZBEHS (X8129), BZBEHP (X8128) and AL00GT (product names; manufactured by NICCA CHEMICAL CO., LTD.).

The content of the antimicrobial agent may be appropriately set without departing from the scope of the present invention. The content of the antimicrobial agent is preferably from 1 to 10 weight % with respect to the total amount of the curable resin composition for the HC layer.

### (Transition Area)

In the optical film of the present invention, the transition area, which has both components of the adhesion layer and the hard coat layer in a mixed state, resides between the adhesion layer and the hard coat layer.

In the transition area, the components of the adhesion layer and the hard coat layer are present in a mixed state, and no interface resides between the transition area and the adhesion layer, and between the transition area and the hard coat layer.

Since the transition area has both components of the adhesion layer and the hard coat layer in a mixed state, the adhesion between the above two layers can be increased, and also a drastic change of the refractive index can be inhibited to decrease the difference between the refractive indexes of the above two layers. In addition, since no interface resides between the above two layers, occurrence of interference fringes between the above two layers can be inhibited.

The transition area can be observed, for example, by means of SEM (scanning electron microscope) after cutting out a cross section of the optical film.

Also, if the transition area resides between the adhesion layer and the hard coat layer, no interference fringe occurs since the components of the above two layers are in a mixed state and there is no interface of the above two layers. Therefore, as a simplified method, the existence of the transition area can be presumed by visually observing no or very few interference fringes.

The thickness of the transition area maybe appropriately adjusted in accordance with required performances, and is preferably from 10 to 300 nm from the viewpoint of sufficiently exerting the effect of function of each layer.

The transition area is not required to contain all components of the adhesion layer and the hard coat layer, and may contain at least the resin which is the same kind as the resin constituting the optically-transparent substrate, and the binder component having photocurability.

### (Composition for Forming Transition Area)

A composition for forming the transition area comprises a resin of the same kind as the resin constituting the optically-transparent substrate, a binder component having photocurability and a third solvent, wherein the resin has glass transition temperature lower than that of the optically-transparent substrate or an absolute value of difference between solubility parameter of the resin and solubility parameter of the optically-transparent substrate is 2 or less, and wherein the total content rate of the resin and the binder component with respect to the total amount of the resin, the binder component and the third solvent in the composition for forming the transition area is higher than the content rate of the resin with respect to the total amount of the resin and the first solvent in the composition for the adhesion layer, and is higher than the content rate of the binder component with respect to the total amount of the binder component and the second solvent in the curable resin composition for the hard coat layer.

The content rate will be explained with an example. If the weight of the resin of the same kind as the resin constituting the optically-transparent substrate in the composition for the adhesion layer is defined as Ma1, the weight of the first solvent is defined as Ms1, the weight of the binder component in the curable resin composition for the HC layer is defined as Mb1, the weight of the second solvent is defined as Ms2, the weight of the resin of the same kind as the resin constituting the optically-transparent substrate in the composition for forming the transition area is defined as Ma2, the weight of the binder component in the composition for forming the transition area is defined as Mb2, and the weight of the third solvent is defined as Ms3, the content rate of the resin of the same kind as the resin constituting the optically-transparent substrate in the composition for the adhesion layer is represented by Ma1/(Ma1+Ms1), the content rate of the binder component in the curable resin composition of the HC layer is represented by Mb1/(Mb1+Ms2), and the total content rate of the resin of the same kind as the resin constituting the optically-transparent substrate and the binder component in the composition for forming the transition area is represented by (Ma2+Mb2)/(Ma2+Mb2+Ms3). They meet the following Formulae (2) and (3):

Ma1/(Ma1+Ms1)<(Ma2+Mb2)/(Ma2+Mb2+Ms3) Formula (2)

Mb1/(Mb1+Ms2)<(Ma2+Mb2)/(Ma2+Mb2+Ms3) Formula (3)

Herein, “/” means the division in four arithmetic operations. That is, Ma/(Ma1+Ms1) means Ma is divided by (Ma1+Ms1).

Since the total content rate of the resin of the same kind as the resin constituting the optically-transparent substrate and the binder component in the composition for forming the transition area is higher than the content rate of the resin in the composition for the adhesion layer and the content rate of the binder component in the curable resin composition for the HC layer, and the HC layer is formed by performing simultaneous application of the composition for the adhesion layer, the composition for forming the transition area, and the curable resin composition for the HC layer so that the coating of the composition for the adhesion layer, the coating of the composition for forming the transition area, and the coating of the curable resin composition for the HC layer are formed in this order on the surface of the optically-transparent substrate, it can be inhibited that the composition for the adhesion layer and the curable resin composition for the HC layer are mixed to be in a uniform state, and the resin and the binder component in the composition for forming the transition area disperse into the composition for the adhesion layer or the curable resin composition for the HC layer having high affinity with themselves respectively. Thereby, the transition area having functions of exhibiting adhesion between the adhesion layer and the HC layer, and inhibiting occurrence of interference fringes between the adhesion layer and the HC layer, can be formed without forming an interface between the transition area and the adhesion layer, and between the transition area and the hard coat layer.

As the resin of the same kind as the resin constituting the optically-transparent substrate contained in the composition for forming the transition area, one described in the composition for the adhesion layer can be used. The resin of the same kind as the resin constituting the optically-transparent substrate in the composition for forming the transition area is preferably the same as the resin of the same kind as the resin constituting the optically-transparent substrate in the composition for the adhesion layer. When the resins of the same kind as the resin constituting the optically-transparent substrate are different from each other between the composition for forming transmission area and the composition for the adhesion layer, the resins of the same kind as the resin constituting the optically-transparent substrate can be different from each other as long as difference of the refractive index is 0.05 or less without departing from the scope of the present invention.

Similarly, as the binder component having photocurability contained in the composition for forming the transition area, one described in the curable resin composition for the HC layer can be used. The binder component in the composition for forming the transition area is preferably the same as the binder component of the curable resin composition for the HC layer. When such binder components are different from each other between the composition for forming the transmission area and the curable resin composition for the HC layer, the binder components may be different from each other as long as difference of the refractive index is 0.05 or less without departing from the scope of the present invention.

In the composition for forming the transition area, the content rate of the resin and the binder component is preferably 80 to 120 parts by weight, more preferably 90 to 110 parts by weight, with respect to 100 parts by weight of the resin. It is preferable that the composition for forming the transition area also contains the thermal crosslinking agent used for the composition for the adhesion layer and the polymerization initiator used for the curable resin composition for the HC layer.

The third solvent is a component for adjusting viscosity of the composition for forming the transition area, and imparting coatability to the composition for forming the transition area.

As the third solvent, one described in the first solvent can be used.

The third solvent may be used alone or in combination of two or more kinds.

The first solvent of the composition for the adhesion layer may be the same as or different from the second solvent of the curable resin composition for the HC layer and the third solvent of the composition for forming the transition area that will be described hereinafter.

In the optical film of the present invention, from the viewpoint of easy formation of the transition area, it is preferable that the content rate of the resin of the same kind as the resin constituting the optically-transparent substrate with respect to the total amount of the resin and the first solvent in the composition for the adhesion layer is 30 to 50 weight %, the content rate of the binder component with respect to the total amount of the binder component and the second solvent in the curable resin composition for the hard coat layer is 30 to 50 weight %, and the content rate of the total amount of the resin and the binder component with respect to the total amount of the resin, the binder component and the third solvent in the composition for forming the transition area is 50 to 80 weight %.

The composition for forming the transition area may contain the polymerization initiator and the leveling agent described in the curable resin composition for the HC layer.

In the case of using the polymerization initiator, the content thereof is preferably from 1 to 10 weight % with respect to the total amount of the composition for forming the transition area.

The content of the leveling agent is preferably from 1 to 10 weight % with respect to the total amount of the composition for forming the transition area.

### (Other Layers)

In the optical film of the present invention, one or more of other functional layers such as a low refractive index layer, an anti-static layer and an anti-fouling layer may be provided on the HC layer as shown in FIG. 2 for the purpose of imparting additional functionality.

Hereinafter, the low refractive index layer, a middle refractive index layer, a high refractive index layer, the anti-static layer and the anti-fouling layer, which can be provided if desired, will be described.

### (Low Refractive Index Layer)

The low refractive index layer is a layer having lower refractive index than that of an adjacent layer on the optically-transparent substrate side thereof, and is formed of a cured product of a composition for the low refractive index layer. A known low refractive index curable resin such as a fluorinated resin or a known fine particle such as a hollow silica fine particle may be appropriately used in the composition for the low refractive index layer so that the low refractive index layer has a lower refractive index than that of the adjacent layer on the optically-transparent substrate side thereof.

### (Middle Refractive Index Layer and High Refractive Index Layer)

The middle refractive index layer and high refractive index layer are layers which can be provided to adjust the reflectance of the optical film of the present invention, for example, by being provided on the optically-transparent substrate side of the low refractive index layer.

The layer thickness of the middle refractive index layer and the high refractive index layer may be appropriately adjusted in accordance with required performances. For example, it can be set in the range from 1 to 5 μm.

Generally, the middle refractive index layer and high refractive index layer mainly contain a binder component and a particle for adjusting the refractive index. As the binder component, one described in the HC layer can be used.

As the particle for adjusting the refractive index, the functional fine particle having high refractive index described in the HC layer may be used.

As for a polymerization initiator and various kinds of additives, which are used if necessary, and a forming method, ones described in the HC layer can be used.

### (Anti-static Layer)

The anti-static layer of the present invention is a layer which can be provided if necessary, to prevent the attachment of dust by inhibiting electrostatic generation, and to prevent electrostatic hazard from the outside when the optical film is incorporated into a liquid crystal display or the like.

The anti-static layer is formed of a cure product of a composition comprising an anti-static agent and a binder component. The layer thickness of the anti-static layer may be appropriately adjusted and is preferably from 10 to 300 nm.

As the performance of the anti-static layer, it is preferable that the surface resistance after forming the optical film is 10¹² Ω/□ or less.

As the anti-static agent, one described in the HC layer can be used. The content of the anti-static agent is preferably from 10 to 50 weight % with respect to the total amount of the composition for the anti-static layer.

As the binder component which is cured to form the anti-static layer, one described in the HC layer can be used.

### (Anti-fouling Layer)

The anti-fouling layer can be provided on the outermost surface of the optical film on the side opposite to the optically-transparent substrate of the optical film for the purpose of preventing the outermost surface of the optical film from contamination. The anti-fouling layer can impart anti-fouling properties and abrasion resistance to the optical film. The anti-fouling layer is formed of a cured product of a composition for the anti-fouling layer comprising an anti-fouling agent and a curable resin composition.

As the anti-fouling agent contained in the composition for the anti-fouling layer, one may be appropriately selected from known anti-fouling agents for use solely, or two or more kinds of anti-fouling agents may be appropriately selected therefrom for use in combination. It is the same with the curable resin contained in the composition for the anti-fouling layer.

### (Method for Producing Optical Film)

The method for producing the optical film of the present invention comprises the steps of:

(i) preparing the composition for the adhesion layer comprising the resin of the same kind as the resin constituting the optically-transparent substrate and the first solvent,

the curable resin composition for the HC layer comprising the binder component having photocurability and the second solvent, and

the composition for forming the transition area comprising the resin of the same kind as the resin constituting the optically-transparent substrate, the binder component having photocurability and the third solvent, wherein the resin has glass transition temperature lower than that of the optically-transparent substrate or an absolute value of difference between solubility parameter of the resin and solubility parameter of the optically-transparent substrate is 2 or less, and wherein the total content rate of the resin and the binder component with respect to the total amount of the resin, the binder component and the third solvent in the composition for forming the transition area is higher than the content rate of the resin with respect to the total amount of the resin and the first solvent in the composition for the adhesion layer, and is higher than the content rate of the binder component with respect to the total amount of the binder component and the second solvent in the curable resin composition for the hard coat layer;

(ii) performing simultaneous application of the composition for the adhesion layer, the composition for forming the transition area, and the curable resin composition for the hard coat layer on one surface of the optically-transparent substrate so that a coating of the composition for the adhesion layer, a coating of the composition for forming the transition area, and a coating of the curable resin composition for the hard coat layer are formed in this order on the surface of the optically-transparent substrate; and

(iii) drying the coatings followed by curing the coating of the curable resin composition for the hard coat layer with light irradiation to form the adhesion layer, the HC layer, and the transition area.

Explanation of the above three compositions prepared in the step (i) is omitted here since each composition explained in each layer may be used.

In the step (ii), the coatings are formed by performing simultaneous application of the composition for the adhesion layer, the composition for forming the transition area, and the curable resin composition for the hard coat layer so that the coating of the composition for the adhesion layer, the coating of the composition for forming the transition area, and the coating of the curable resin composition for the hard coat layer are formed in this order on the surface of the optically-transparent substrate.

By performing the simultaneous application, the transition area having no interface can be easily formed.

A method of the simultaneous application is not particularly limited as long as it is a method wherein the above three compositions can be simultaneously applied, and a conventionally-known method of simultaneous application can be used. Examples of the method of simultaneous application include a method using a slide coater and an extrusion die coater. The simultaneous application is preferably performed by means of the slide coater from the viewpoint of productivity and uniformity of thickness of each layer.

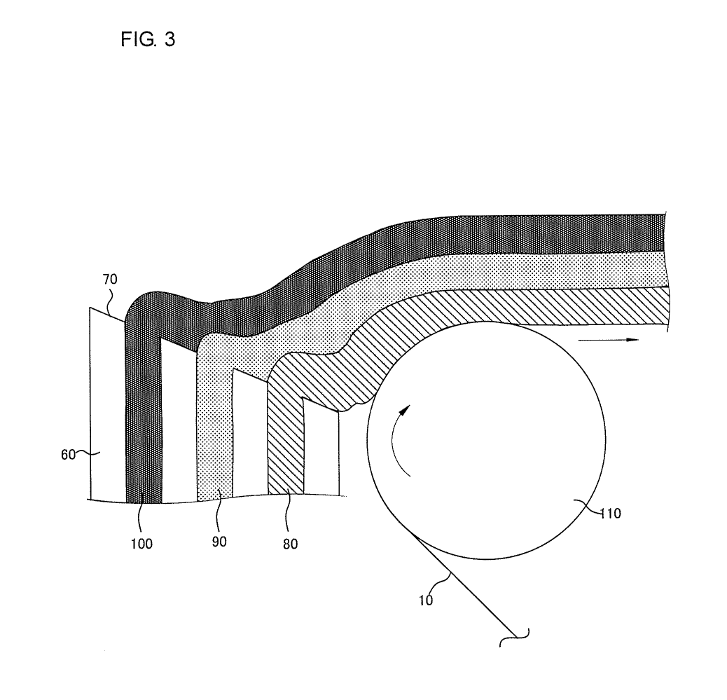

FIG. 3 is a schematic view showing one example of simultaneous application of the above three compositions performed on the optically-transparent substrate by means of a slide coater.

The simultaneous application of the composition 80 for the adhesion layer, the composition 90 for forming the transition area, and the curable resin composition 100 for the HC layer is performed by providing the compositions from slits provided on a slide surface 70 of a coating head 60 so that the coating of the composition 80 for the adhesion layer, the coating of the composition 90 for forming the transition area, and the coating of the curable resin composition 100 for the HC layer are formed in this order on the surface of the optically-transparent substrate 10. In order to simplify the explanation, the optically-transparent substrate 10 is shown as a line, and the state before the composition for forming the transition area disperses into the composition for the adhesion layer and the curable resin composition for the HC layer, wherein the above three compositions are laminated, is shown.

In the step (iii), the coatings are dried followed by curing the coating of the curable resin composition for the hard coat layer with light irradiation to form the adhesion layer, the HC layer, and the transition area.

The drying method is not particularly limited, and is appropriately adjusted in accordance with the components of the compositions, and the layer thickness of the coatings. For example, in the case of using toluene as the first solvent, the drying may be performed at 80° C. for 1 minute.

For the light irradiation, in many cases, ultraviolet rays, visible light, electron beam, ionizing radiation or the like is used. In the case of ultraviolet curing, for example, ultraviolet rays emitted from a light source such as an ultra-high-pressure mercury lamp, a high-pressure mercury lamp, a low-pressure mercury lamp, a carbon arc lamp, a xenon arc lamp or a metal halide lamp can be used. The light irradiance level maybe appropriately adjusted in accordance with components of the compositions and layer thickness of the coatings. For example, the light irradiance level is preferably from 50 to 200 mJ/cm² as the integral exposure amount of light at the ultraviolet wavelength of 365 nm.

The above described other functional layers such as the low refractive index layer and the high refractive index layer may be formed by applying a composition for the functional layer separately from the above three compositions followed by curing or drying, or by simultaneous application of the composition of the functional layer together with the above three compositions followed by curing or drying.

For example, in order to inhibit occurrence of interference fringes between the HC layer and the functional layer, one of the above described other functional layers may be formed on the HC layer by the following manner. Firstly, a composition for forming a second transition area may be prepared, wherein the composition for forming the second transition area contains binder components used in curable resin composition for the HC layer and composition for the functional layer respectively and a solvent, and the above three compositions, which are the curable resin composition for the HC layer, the composition for forming the second transition area and the functional layer, meet the relationship of the content rate shown in the formulae (2) and (3) described in the composition for forming the transition area. Next, simultaneous application of the compositions may be performed so that a coating of the composition for forming the second transition area is formed between a coating of the curable resin composition for the HC layer and a coating of the composition for the functional layer. In such a manner, the second transition area can be formed between the HC layer and the functional layer, and difference of the refractive index between the layers decreases. Thereby, interference fringes can be inhibited and also adhesion can be increased. This method can be used for the case of forming more layers.

In addition, if a composition for a high refractive index layer, for example, is used in place of the curable resin composition for the HC layer, and simultaneous application of three compositions including the composition for adhesion layer, the composition for a high refractive index layer and the composition for forming the transition area is performed, the adhesion layer and the high refractive index layer can be formed on the optically-transparent substrate, and a transition area containing the components of the adhesion layer and the high refractive index layer can be formed between the adhesion layer and the high refractive index layer.

By using such a production method of the present invention, adhesion can be increased while inhibiting occurrence of interference fringes between the functional layer other than the HC layer and the optically-transparent substrate.

### EXAMPLES

Hereinafter, the present invention will be explained in detail with reference to examples. The scope of the present invention may not be limited to the following examples, however.

As an optically-transparent substrate (1), a polyethylene terephthalate film (product name: COSMOSHINE A4100; manufactured by TOYOBO CO., LTD.; glass transition temperature: 120° C.; solubility parameter: 11.5) having a thickness of 100 μm with no primer layer (with no surface treatment) was used.

As an optically-transparent substrate (2), a polyethylene terephthalate film (product name: COSMOSHINE; manufactured by TOYOBO CO., LTD.; high refractive index product; glass transition temperature: 120° C.; solubility parameter: 11.5) having a thickness of 100 μm with a primer layer was used.

As a resin of the same kind as a resin constituting the optically-transparent substrate, amorphous polyester (product name: VYLON 240; manufactured by TOYOBO CO., LTD.; glass transition temperature: 60° C.; solubility parameter: 11) was used.

As a binder component, dipentaerythritol hexaacrylate (DPHA) (manufactured by DAICEL-CYTEC Company, Ltd.) was used.

As the first and third solvents, toluene (manufactured by KANTO CHEMICAL CO., INC.) was used.

As the second solvent, methyl isobutyl ketone (MIBK) (manufactured by KANTO CHEMICAL CO., INC.) was used.

As a polymerization initiator, Irgacure 907 (product name; manufactured by Ciba Japan K. K.) was used.

As a cross-linking agent, an isocyanate cross-linking agent (product name: Duranate22A-75PX; manufactured by ASAHI KASEI CHEMICALS CORPORATION) was used.

### (Preparation of Composition for Adhesion Layer)

A composition for an adhesion layer was prepared by compounding components of the following composition.

Amorphous polyester: 32 parts by weight

Isocyanate cross-linking agent: 12 parts by weight

Toluene: 58 parts by weight

### (Preparation of Curable Resin Composition for HC Layer)

A curable resin composition for a HC layer was prepared by compounding components of the following composition.

DPHA: 29 parts by weight

Irgacure 907: 1.5 parts by weight

MIBK: 52 parts by weight

### (Preparation of Composition for Forming Transition Area)

A composition for forming a transition area was prepared by compounding components of the following composition.

Amorphous polyester: 59 parts by weight

Isocyanate cross-linking agent: 15 parts by weight

DPHA: 57 parts by weight

Irgacure 907: 2 parts by weight

Toluene: 68 parts by weight

### Example 1

By means of a slide coater as shown in FIG. 3, the composition for an adhesion layer, the composition for forming a transition area and the curable resin composition for a HC layer (compositions 80, 90 and 100 in FIG. 3) prepared as above were simultaneously applied on one surface of the optically-transparent substrate (1) to form coatings. Then, the coatings were dried in an oven at 80° C. for 1 minute followed by ultraviolet irradiation at the exposure amount of 100 mJ/m², thus, an optical film was prepared.

### Comparative Example 1

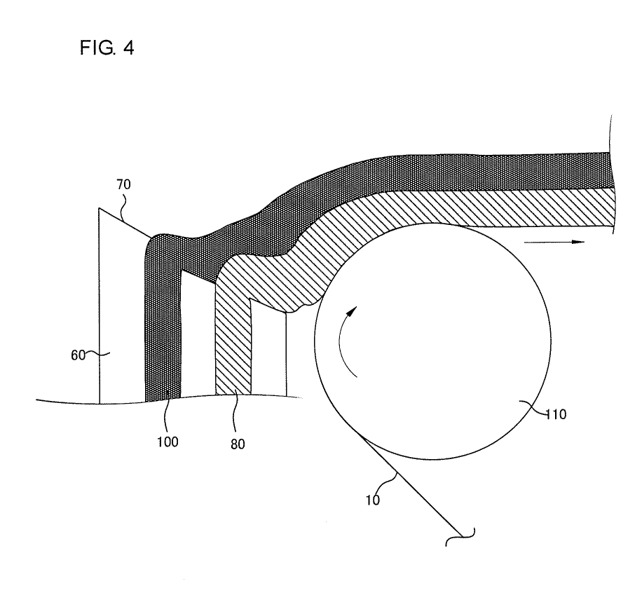

By means of a slide coater as shown in FIG. 4, the composition for an adhesion layer and the curable resin composition for a HC layer (compositions 80 and 100 in FIG. 4) prepared as above were simultaneously applied on one surface of the optically-transparent substrate (1) to form coatings. Then, the coatings were dried in an oven at 80° C. for 1 minute followed by ultraviolet irradiation at the exposure amount of 100 mJ/m², thus, an optical film was prepared.

### Comparative Example 2

Each of the composition for an adhesion layer, the composition for forming a transition area, and the curable resin composition for a HC layer prepared above was sequentially applied on one surface of the optically-transparent substrate (1) and dried in an oven at 80° C. for 1 minute to form coatings. Further, the coatings were subjected to ultraviolet irradiation at the exposure amount of 100 mJ/m², thus, an optical film was prepared.

### Comparative Example 3

The curable resin composition for a HC layer prepared as above was applied on the surface having a primer layer of the optically-transparent substrate (2) to form a coating. Then, the coating was dried in an oven at 80° C. for 1 minute followed by ultraviolet irradiation at the exposure amount of 100 mJ/m², thus, an optical film was prepared.

The presence of interference fringes, pencil hardness and adhesion of the optical films prepared in Example and Comparative examples were respectively evaluated by the evaluation method mentioned below. Table 1 shows the results, the coating method, and use of the composition for forming a transition area.

### (Evaluation: Interference Fringes)

A black tape was applied on the PET substrate side of the optical film. Then, the presence or absence of interference fringes was visually observed under a three band fluorescent lamp.

### (Evaluation: Pencil Hardness)

Pencil hardness test defined in JIS K5600-5-4 (1999) was performed on the prepared optical films by means of the pencil having a hardness of 2H with a load of 9.8 N to determine the number of generated scratches when making five lines with the pencil and to obtain the number of lines without scratch, after conditioning the humidity of the optical films for two hours under the condition of a temperature of 25° C. and a relative humidity of 60%. In the evaluation results, “⅘” means that no scratch was made by four lines among five lines.

### Evaluation: Adhesion)

The optical films right after preparation and the optical films after conditioning the humidity for 24 hours under the condition of a temperature of 60° C. and a relative humidity of 90% were respectively evaluated as follows. In accordance with a method of a cross cut test defined in JIS K5400, 11 lengthwise cuts and 11 crosswise cuts at 1 mm intervals were made on the surface of the hard coat layer of the optical films to make 100 squares. Then, Cellotape (registered trademark; manufactured by Nichiban Co., Ltd.) was applied on the squares, and promptly pulled in a right angled direction to peel the squares. The ratio of squares remained without peeling, which is calculated based on the following criteria, was referred to as an adhesion rate.

Adhesion rate (%)=(the number of squares remained without peeling/100 [total number of squares])×100

TABLE 1
Table1

| | Types of | | Use of | | | Adhesion rate (%) | |
|---|---|---|---|---|---|---|---|
| | optically- | | composition for | | Pencil | | After |
| | transparent | | forming | Interference | hardness | Right after | conditioning |
| | substrate | Coating method | transition area | fringes | (2H) | preparation | humidity |
| Example 1 | 1 | Simultaneous | YES | Absent | 5/5 | 100 | 100 |
| | | application | | | | | |
| Comparative | 1 | Simultaneous | NO | Absent | — | — | — |
| example 1 | | application | | (mixed) | | | |
| Comparative | 1 | Sequential | YES | Present | 4/5 | 0 | 0 |
| example 2 | | application | | | | | |
| Comparative | 2 | Single layer of | NO | Absent | 5/5 | 100 | 90 |
| example 3 | | HC layer | | | | | |

### RESULTS

In Example 1, no interference fringe was observed, and excellent results of pencil hardness, and adhesion evaluation right after preparation and after conditioning the humidity were obtained.

To the contrary, in Comparative example 1, in which only two kinds of compositions (the composition for the adhesion layer and the curable resin composition for the HC layer) were simultaneously applied on the optically-transparent substrate without using the composition for forming the transition area, since both compositions described above were mixed, no interference fringe was observed but an adhesion layer and a HC layer were not formed, and the adhesion rate was not obtained either.

In Comparative example 2, in which each composition was sequentially applied on the optically-transparent substrate using the same composition as in Example 1, the hardness was excellent, however, since an interface was formed between layers and the transition area of the present invention was not obtained, interference fringes were observed, and the pencil hardness was lower than that of Example 1. In addition, the adhesion rate was 0% so that the adhesion was also poor.

In Comparative example 3, in which only the HC layer was formed on the PET substrate having the primer layer, the adhesion after conditioning the humidity decreased so that the durable adhesion was also poor.

What is claimed is:

1. An optical film comprising an optically-transparent substrate, an adhesion layer and a hard coat layer, the adhesion layer and the hard coat layer being provided in this order on one surface of the optically-transparent substrate,
wherein the adhesion layer is made of a composition mainly comprising a resin of the same kind as a resin constituting the optically-transparent substrate, and a glass transition temperature of the adhesion layer is lower than that of the optically-transparent substrate,
wherein the hard coat layer is formed of a cured product of a curable resin composition for the hard coat layer, and
wherein a transition area, which has both components of the adhesion layer and the hard coat layer in a mixed state, resides between the adhesion layer and the hard coat layer.

2. The optical film according to claim 1, wherein the optically-transparent substrate is an optically-transparent substrate having an untreated surface.

3. The optical film according to claim 2, wherein the optically-transparent substrate having the untreated surface is a polyethylene terephthalate substrate, and the resin in the adhesion layer is amorphous polyethylene terephthalate.

4. An optical film comprising an optically-transparent substrate, an adhesion layer and a hard coat layer, the adhesion layer and the hard coat layer being provided in this order on one surface of the optically-transparent substrate,
wherein the adhesion layer is made of a composition mainly comprising a resin of the same kind as a resin constituting the optically-transparent substrate, and an absolute value of difference between solubility parameter of the adhesion layer and solubility parameter of the optically-transparent substrate is 2 or less, the solubility parameter being calculated from square root of cohesive energy density,
wherein the hard coat layer is formed of a cured product of a curable resin composition for the hard coat layer, and
wherein a transition area, which has both components of the adhesion layer and the hard coat layer in a mixed state, resides between the adhesion layer and the hard coat layer.

5. The optical film according to claim 4, wherein the optically-transparent substrate is an optically-transparent substrate having an untreated surface.

6. The optical film according to claim 5, wherein the optically-transparent substrate having the untreated surface is a polyethylene terephthalate substrate, and the resin in the adhesion layer is amorphous polyethylene terephthalate.

7. An optical film obtained by the steps of:
preparing a composition for an adhesion layer comprising a resin of the same kind as a resin constituting an optically-transparent substrate and a first solvent, wherein the resin has a glass transition temperature lower than that of the optically-transparent substrate,
a curable resin composition for a hard coat layer comprising a binder component having photocurability and a second solvent, and
a composition for forming a transition area comprising a resin of the same kind as the resin constituting the optically-transparent substrate, a binder component having photocurability and a third solvent, wherein the resin has a glass transition temperature lower than that of the optically-transparent substrate, and wherein a total content rate of the resin and the binder component with respect to a total amount of the resin, the binder component and the third solvent in the composition for forming the transition area is higher than a content rate of the resin with respect to a total amount of the resin and the first solvent in the composition for the adhesion layer, and is higher than a content rate of the binder component with respect to a total amount of the binder component and the second solvent in the curable resin composition for the hard coat layer;
performing simultaneous application of the composition for the adhesion layer, the composition for forming the transition area, and the curable resin composition for the hard coat layer on one surface of the optically-transparent substrate so that a coating of the composition for the adhesion layer, a coating of the composition for forming the transition area, and a coating of the curable resin composition for the hard coat layer are formed in this order on the surface of the optically-transparent substrate; and
drying the coatings followed by curing the coating of the curable resin composition for the hard coat layer with light irradiation.

8. The optical film according to claim 7, wherein the optically-transparent substrate is an optically-transparent substrate having an untreated surface.

9. The optical film according to claim 8, wherein the optically-transparent substrate having an untreated surface is a polyethylene terephthalate substrate, and the resin in the composition for the adhesion layer is amorphous polyethylene terephthalate.

10. The optical film according to claim 7, wherein the simultaneous application is performed by means of a slide coater.

11. The optical film according to claim 7,
wherein the content rate of the resin with respect to the total amount of the resin and the first solvent in the composition for the adhesion layer is 30 to 50 weight %,
wherein the content rate of the binder component with respect to the total amount of the binder component and the second solvent in the curable resin composition for the hard coat layer is 30 to 50 weight %, and
wherein the content rate of the total amount of the resin and the binder component with respect to the total amount of the resin, the binder component and the third solvent in the composition for forming the transition area is 50 to 80 weight % .

12. An optical film obtained by the steps of:
preparing a composition for an adhesion layer comprising a resin of the same kind as a resin constituting an optically-transparent substrate and a first solvent, wherein an absolute value of difference between solubility parameter of the resin and solubility parameter of the optically-transparent substrate is 2 or less, the solubility parameter being calculated from square root of cohesive energy density,
a curable resin composition for a hard coat layer comprising a binder component having photocurability and a second solvent, and
a composition for forming a transition area comprising a resin of the same kind as the resin constituting the optically-transparent substrate, a binder component having photocurability and a third solvent, wherein an absolute value of difference between solubility parameter of the resin and solubility parameter of the optically-transparent substrate is 2 or less, and wherein a total content rate of the resin and the binder component with respect to a total amount of the resin, the binder component and the third solvent in the composition for forming the transition area is higher than an amount of the resin with respect to a total amount of the resin and the first solvent in the composition for the adhesion layer, and is higher than an amount of the binder component with respect to a total amount of the binder component and the second solvent in the curable resin composition for the hard coat layer;
performing simultaneous application of the composition for the adhesion layer, the composition for forming the transition area, and the curable resin composition for the hard coat layer on one surface of the optically-transparent substrate so that a coating of the composition for the adhesion layer, a coating of the composition for forming the transition area, and a coating of the curable resin composition for the hard coat layer are formed in this order on the surface of the optically-transparent substrate; and
drying the coatings followed by curing the coating of the curable resin composition for the hard coat layer with light irradiation.

13. The optical film according to claim 12, wherein the optically-transparent substrate is an optically-transparent substrate having an untreated surface.

14. The optical film according to claim 13, wherein the optically-transparent substrate having an untreated surface is a polyethylene terephthalate substrate, and the resin in the composition of the adhesion layer is amorphous polyethylene terephthalate.

15. The optical film according to claim 12, wherein the simultaneous application is performed by means of a slide coater.

16. The optical film according to claim 12,
wherein the content rate of the resin with respect to the total amount of the resin and the first solvent in the composition for the adhesion layer is 30 to 50 weight %,
wherein the content rate of the binder component with respect to the total amount of the binder component and the second solvent in the curable resin composition for the hard coat layer is 30 to 50 weight %, and
wherein the content rate of the total amount of the resin and the binder component with respect to the total amount of the resin, the a binder component and the third solvent in the composition for forming the transition area is 50 to 80 weight %
